(19) United States
(12) Patent Application Publication
(10) Pub. No.: US 2006/0218311 A1
(43) Pub. Date: Sep. 28, 2006

(54) Simplifying integration of field devices accessible by different network protocols into a field device management system

(76) Inventors: Prashant Maranat, Bangalore (IN); Rizwan Mohammed, Bangalore (IN)

Correspondence Address: HONEYWELL INTERNATIONAL INC., 101 COLUMBIA ROAD, P O BOX 2245, MORRISTOWN, NJ, 07962-2245, US

(21) Appl. No.: 11/145,746

(22) Filed: Jun. 6, 2005

(30) Foreign Application Priority Data
Mar. 28, 2005 (IN) 314/CHE/2005

(51) Int. Cl. G06F 3/00

(52) U.S. Cl. 710/19

(57) ABSTRACT

A common interface is provided using which an application layer interfaces with a device corresponding to each type of control network protocol. Substantial portion of challenge in integrating management of field devices accessible by a new control network protocol entails development of protocol specific portions which are responsive to procedures according to the common interface. Due to the separation of the control network protocol specific portions and upper layers using the common interface, the integration is simplified.

### RELATED APPLICATIONS

The present application is related to and claims priority from the co-pending India Patent Application entitled, “Simplifying Integration Of Field Devices Accessible By Different Network Protocols Into A Field Device Management System”, Serial Number: 314/CHE/2005, Filed: 28 Mar. 2005, naming the same inventors as in the subject patent application.

The present application is also related to the following co-pending U.S. Applications, which are filed on even date herewith, and are incorporated in their entirety herewith:

1. Entitled, “Managing Field Devices Having Different Device Description Specifications in a Process Control System”, Serial Number: UNASSIGNED, Filed: UNASSIGNED, Attorney Docket Number: H0008169, Inventors: BHANDIWAD et al;

2. Entitled, “Presenting Status Information of Field Devices in Process Control Plants”, Serial Number: UNASSIGNED, Filed: UNASSIGNED, Attorney Docket Number: H0008316, Inventors: RAMANATHAN et al;

3. Entitled, “Display of Historical Information Related to Field Devices Used in Process Control Plants”, Serial Number: UNASSIGNED, Filed: UNASSIGNED, Attorney Docket Number: H0008312, Inventors: Surjya Narayana et al; and

### BACKGROUND OF THE INVENTION

1. Field of the Invention

The present invention generally relates to process control systems, and more specifically to an architecture which simplifies integration of field devices accessible by different network protocols into a field device management system.

2. Related Art

A process control plant generally contains several field devices connected to various control networks to perform a desired control process. To enable such control process, each field device operates to measure various parameter such as temperature, flow, pressure, etc., and control elements such as valves, switches and transmitters (which transmit any desired information to a processing system.

Various parameter thus measured are presented as variables having values proportionate to measured parameters. For example, field devices may measure pressure through pressure sensor and control valves to maintain the pressure level in a boiler (in general equipment) at a desired value.

There is a general need to manage field devices provided in a process control plant. Management generally refers to tasks such as monitoring and configuration of the devices. In general, a field device management system is provided, which provides users the ability to manage the devices from remote locations (distant from the field devices).

One problem in management of field devices is that different field devices are accessible by different network protocols. A network protocol specifies a compatible set of electrical, physical and protocol (packet format and other interactions) interfaces using which different types of devices connected to a corresponding network type can be accessed. For example, some field devices are accessible using HART protocol (HART Communication Foundation, 9390 Research Boulevard, Suite I-350, Austin, Tex. 78759, USA (http://www.hartcomm.org)) and some other protocols are accessible using Profi bus/protocol.

Due to such differences in protocols, in one prior approach, a separate management station is provided for field devices accessible by corresponding network protocols. In such a situation, integration of field devices accessible by new network protocols would require additional management stations. Such an approach leads to fragmentation of information, higher costs, and inefficient management.

An alternative approach overcomes some of the disadvantages noted above by providing a single management station to manage field devices accessible by multiple control networks or devices. Such management stations are provided as a solution to manage control networks or field devices accessible by pre-specified protocols. However, it is often desirable that a process control plant have the ability to add/use other types of control networks, and also manage all such networks (and devices connected thereto) from a single management station.

Accordingly, there is a need to simplify integration of devices accessible by various network protocols.

### SUMMARY

An aspect of the present invention facilitates integration of management of field devices into a field device management system, wherein the field devices are accessible by a new network protocol. Such a feature is attained by providing a common interface containing a first set of procedures and a second set of procedures, wherein the first set of procedures are invoked by an upper layer to initiate management actions on a device of interest independent of a protocol by which the device is accessible, wherein each of the second set of procedures is implemented by the upper layer, wherein integration of management of the field devices can be attained by adding a device manager which implements the first set of procedures according to the new network protocol, and communicates with said upper layer using the second set of procedures, whereby the integration is simplified due to said common interface.

Further features and advantages of the invention, as well as the structure and operation of various embodiments of the invention, are described in detail below with reference to the accompanying drawings. In the drawings, like reference numbers generally indicate identical, functionally similar, and/or structurally similar elements. The drawing in which an element first appears is indicated by the leftmost digit(s) in the corresponding reference number.

### BRIEF DESCRIPTION OF THE DRAWINGS

The present invention will be described with reference to the accompanying drawings, which are described briefly below.

FIG. 1 is a block diagram illustrating an example environment in which various aspects of the present invention can be implemented.

FIG. 2 is a block diagram illustrating an approach which simplifies integration of management of field devices accessible by new network protocols, according to an aspect of the present invention.

FIG. 3 is a flowchart illustrating the integration of management of field devices accessible new network protocols, according to an aspect of the present invention.

FIG. 4 is a block diagram illustrating the details of digital processing system implemented substantially in the form of software in an embodiment of the present invention.

### DETAILED DESCRIPTION

1. Overview

An aspect of the present invention provides easy integration of devices accessible by a new network protocol into a pre-existing central server by providing a common interface. Substantial portion of the task of integration of the new network protocol may merely require development of software modules consistent with the common interface. As a result, the overhead of integration of new network protocols may also be simplified. In one embodiment described below, the common interface is defined as a set of procedures (also generally referred to as methods in the Object Oriented Environments).

Several aspects of the invention are described below with reference to examples for illustration. It should be understood that numerous specific details, relationships, and methods are set forth to provide a full understanding of the invention. One skilled in the relevant art, however, will readily recognize that the invention can be practiced without one or more of the specific details, or with other methods, etc. In other instances, well-known structures or operations are not shown in detail to avoid obscuring the invention.

2. Example Environment

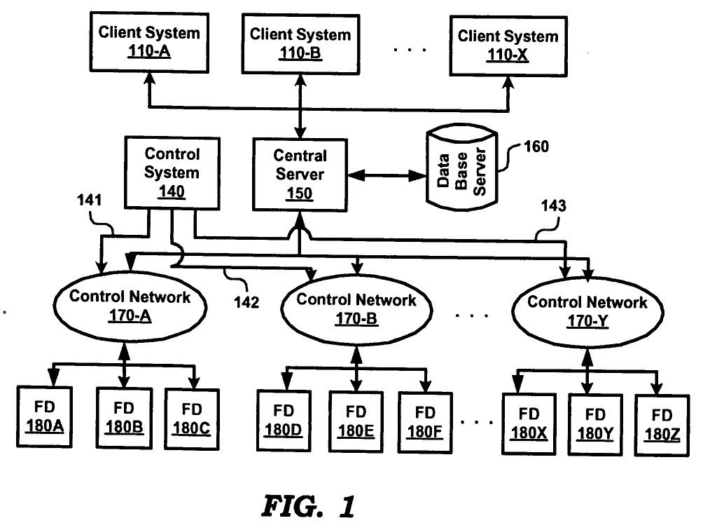

FIG. 1 is a block diagram illustrating the details of an example environment in which several aspects of the present invention can be implemented. The block diagram is shown containing client systems 110A-110X, central server 150, database server 160, control networks 170A-170Y, control system 140, and field devices (FD)180A-180Z. Each block is described below in detail.

Client systems 110A through 110X provides a user interface which enables users to view various status information (representing the present state data or configuration data, as well as results of various requests) of interest and configure field devices 180A through 180Z. Each client system may subscribe to central server 150 for specific information elements for displaying and/or send specific data to configure field devices (based on inputs received from a user). Client systems 110A through 110Z may communicate with central server 150 according to any pre-specified protocols, and the communication may be implemented in a known way.

Each of control networks 170A-170Y provides connectivity between central server 150, control system 140 and a number of corresponding field devices (e.g., 180A through 180C in case of control network 170A). For illustration, it is assumed that each control network supports data exchange according to a corresponding network protocol (such as HART, Control Net, and Foundation Field Bus well known in the relevant arts). Accordingly, field devices supporting a particular network protocol are connected to corresponding control network.

Control system 140 issues commands (on paths 141, 142, and 143) to control the operation of field devices 180A through 180Z on respective control network. The field devices are controlled to implement desired control processes (e.g., oil refinery, manufacturing plant). Database server 160 provides a central repository for storing information related to configuration of field devices, status of field devices, maintenance schedules, etc.

Field devices 180A through 180Z perform various operations under the control of control system 140 to implement a desired manufacturing process. In addition (or as a part of supporting such a process), each field device may be implemented to support various management commands (for information gathering as well as configuration) received from central server 150. Field devices 180A through 180Z receive/transmit relevant data from/to central server 150 on corresponding control network to which each device is connected.

Central server 150 receives requests for information in the form of subscription from various clients 110A through 110X. The requested information may be retrieved from a database server 160 (in case of historical information) or by communicating with field devices over corresponding control network. In order to support various management features, central server 150 communicates to field devices on corresponding control network 170A-170Y. Central server 150 may also support configuration of devices based on requests received from client systems 110A-110X. Other features such as audit trail, may also be implemented, in central server 150.

As may be appreciated by examining FIG. 1; a single server is used to communicate with field devices across different control networks, even if the control networks are implemented using different network protocols. Due to the use of a single server, costs may be reduced and fragmentation of information is avoided.

According to an aspect of the present invention, central server 150 is implemented to enable easy integration of management of field devices which are accessible by new network protocols. Thus, the overhead of addition of field devices accessible by new control networks, may be reduced. The manner in which such easy integration may be facilitated, is described below with examples.

3. Implementation of Central Sever

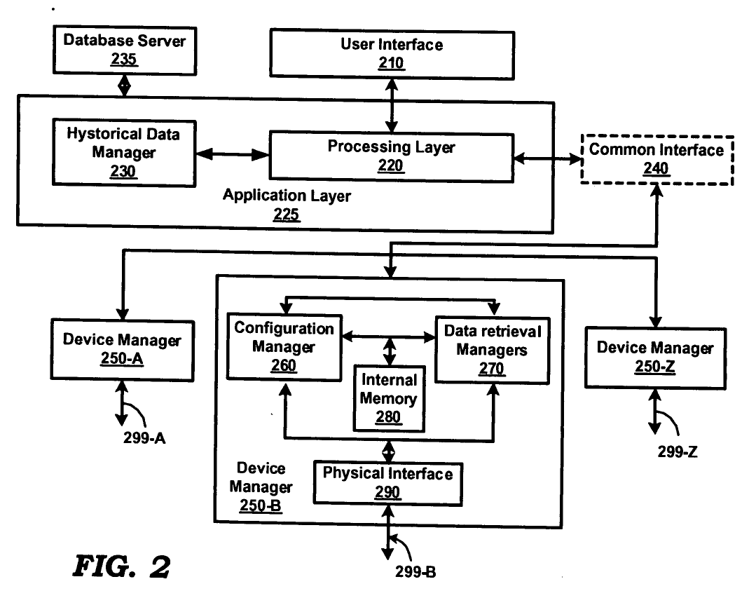

FIG. 2 is a block diagram illustrating the manner in which a central server can be implemented to enable easy integration of management of field devices accessible by new control network protocols. The block diagram is shown containing user interface 210, application layer 225 (in turn shown containing processing layer 220, and historical data manager 230), database server 235, common interface 240, and device managers 250A-250Z. Each component is described below in further detail.

User interface 210 provides users a suitable interface to manage (receive desired information, configuration, etc.) field devices of interest. For example, a user may be provided interface to specify requests for status information of field devices, and user interface 210 provides display of the corresponding information. Accordingly, user interface 210 sends to processing layer 220 parameters representing status of interest (which is received from the user) and receives the corresponding information.

Also, user interface 210 receives configuration requests from users, and causes the corresponding configuration to be performed. Thus, data representing the requests as well as corresponding parameters are sent to processing layer 220, and the result of configuration request is received from the processing layer. User interface 210 provides a suitable display/interface corresponding to both status information and configuration requests.

User interface 210 may be implemented in each of client systems 110A-110X and remaining layers of FIG. 2 may be implemented in central server 150, and thus interactions between user interface 210 and processing layer 220 is/are supported by communication between a client system and central server 150.

Processing layer 220 processes the requests for status information and configuration of field devices received from user interface 210. To perform such processing, processing layer 220 determines the specific elements (field devices or control networks) indicated to be of interest in user interface 210, and interfaces with one of history data manager 230, or device managers 250A-Z to perform the corresponding request (as described in further detail below). The interfaces with the device manager is provided through common interface 240, also described in detail below.

Typically, requests for retrieval of historical data and for storing data in database server 235, are forwarded to historical data manager 230. On the other hand, a request for present status information and configuration of the field devices is forwarded to respective device manager 250A-250Z.

Processing layer 220 receives a response for each of the requests sent to the respective device manager. The received information is forwarded to the respective client system from which the corresponding request is received, and also to historical data manager 230 for storing in case the information is to be later presented as historical information. In addition, processing layer also forwards information about user activity and user status to historical data manager to provide various management features such as audit trails, etc.

Historical data manager 230 stores data representing status of field devices along with a present time stamp and retrieves the corresponding data based on the time reference indicated in a hysterical data request received from processing layer 220. The data may be stored in a separate database server 235.

Each device manager 250A-Z contains configuration manager 260, data retrieval manager 270, internal memory 280 and physical interface 290, while only the details of device manager 250B is shown/described for conciseness. Each of the components is described below in further detail.

Data retrieval manager 270 processes requests corresponding to retrieval of data from field devices and configuration manager 260 processes requests requesting configuration of the field devices. In general, commands are issued to the respective field device to process the requests. Internal memory 280 is used to store status information of the devices presently being accessed by one or more users.

Physical interface 290 provides the electrical and protocol interface to send and receive data packets.to/from the device of interest. The received data is provided to respective managers 260 or 270. Each device manager may contain a number of physical interfaces to handle devices connected to different protocol/physical interfaces.

Common interface 240 provides a common framework/convention according to which information (data) is exchanged between device managers 250A-250Z and processing layer 220. As common interface 240 represents merely a common framework (as opposed to active software portions), the block is shown with dotted lines.

Due to the use of the common interface, integration of new control network protocols may merely require implementation of a corresponding device manager according to the common framework, while the upper layers (application layer, historical data manager and user interface) can potentially be used without requiring substantial changes. The development efforts associated with such integration may be simplified as a result.

In general, common interface 240 needs to support various functionalities sought to be implemented by the overall field device management system. The description is accordingly continued with reference to example functionality features, and the associated portion of common interface 240. For illustration, the following four functionalities are addressed in illustrating the principles underlying the implementation of common interface 240:

1) Generating network map.

2) Display of status information

3) Configuration

4) Executing Actions

4. Common Interface For Generating Network Map

Network map generally provides information (e.g., in the form of an understandable diagram) containing a list of devices connected to a specified network and the state of the devices typically indicating whether the device is active or inactive. A user may then select a specific device from the network map to request additional information of interest. The manner in which a network map corresponding to various networks accessible by different protocols can be generated by using common interface 240 is described below.

According to an aspect of the present invention, a set of procedures (also known as methods) are provided as common interface 240 to obtain network map. In an embodiment, a procedure BuildNetwork, with network ID as parameter, is invoked by processing layer 220 when a network map is to be determined (e.g., in response to user actions or at the time of initialization).

Based on the Network ID, device managers 250A-Z managing devices connected to the network corresponding to the specified network ID executes the procedure/method and returns the requested information to processing layer 220. Processing layer 220 forwards the network information to user interface 210 and/or historical data manager 230.

Thus, each device manager 250A-250Z may be required to implement a method BuildNetwork to establish connection with the specified network and obtain information related to devices connected to network. The device managers may use one or more physical interface 290 for establishing the necessary connection, as well as to address other protocol aspects such as signal levels and handshaking. Device managers 250A-250Z may retrieve device information such as type of device, manufacturer Id, whether device is active or disconnected etc., and forward the information to processing layer 220.

Another procedure NotifyNetworkChange may be used to notify changes in the network.Device manager 250A forwards ccomparison result representing the changes in network map from the previous update to processing layer 220. Processing layer 220 may invoke BuildNetwork procedure (implemented within device manager 250A) at initialization time (to build the network status), and NotifyNetworkChange (implemented by device manager 250A) may notify processing layer 220 of any changes thereafter.

Thus, to facilitate integration devices accessible by a new network protocol, a developer needs to implement BuildNetwork procedure within device manager 250B. Similarly, NotifyNetworkChange procedure is also implemented in device manager 250A to report back later changes. The implementation of BuildNetwork procedure depends generally on the specific protocol sought to be integrated, and will be apparent to one skilled in the relevant arts by reading the disclosure provided herein.

Depending on additional features required to be supported in the field device management system, device managers 250A may need to be implemented with more procedures consistent with common interface 240. The description is thus continued with respect display of status information, a feature provided by the field device management system.

5. Common Interface For Displaying Status Information

Display of status information enables a user to monitor the status of field devices connected to various control networks at various locations from a remote/single location. In one embodiment, user interface 210 displays a list of various networks presently being monitored, and a list of all the devices connected to a specific control network selected by the user. When a user selects one of the field devices, the corresponding status (present state, configuration data, etc., as noted above) information is displayed in the form of a tree structure. In an embodiment, the tree structure is displayed based on the information present in a data structure referred to as menu in the device description (DD). Thus, the tree structure is the visual representation of the menu structure in the DD. The user navigates the tree structure to specify specific information elements of interest (representing current configuration or status), and the corresponding values are displayed.

When a user selects an information element from the menu, user interface 210 causes processing layer 220 to subscribe for the corresponding information. As a result of the subscription, user interface 210 receives updated values in real time as long as the subscription continues. The user may terminate selection, for example, by ending the session or by navigating to other portions of the menu.

However, some of the menus (“dynamic menus”) are determined by the present values of some of the variables (referred as dynamic variables). When a user subscribes to a dynamic menu, user interface 210 sends data representing the subscribed menu to processing layer 220, and receives the dynamic menu from processing layer 220. The received menu is displayed for the user. Consistent with the approach in the previous paragraph, the dynamic menu (and values of the elements therein) are periodically updated or sent to user interface 210 when the corresponding subscription exists.

Processing layer 220 (representing an upper layer) uses common interface 240 to interact with respective device managers 250A-250Z to obtain the subscribed data, including dynamic menu, static variables (which do not change) and dynamic variables (which change over time, e.g., present temperature of a boiler). Processing layer 220 receives the requested data from the device managers 250A-250Z and forwards the same for display to user interface 210. In case, the data is to be stored for later retrieval as historical data, processing layer 220 sends a copy of the data to historical data manager 230 for storing in database 235.

The manner in which processing layer 220 interacts with device managers 250A-250Z using common interface 240 to retrieve various data from the devices connected to different control network is described below.

According to an aspect of the present invention, a set of procedures are provided according to common interface 240 to obtain present data from the field devices connected to various control network. In an embodiment, procedures LoadDevice, UnloadDevice, SubscribeParameter, and UnsubscribeParameter are implemented in each device manager 250A-250Z, and invoked by processing layer 220. Each device manager may be required to implement these procedures according to below description.

LoadDevice, having a device path (uniquely identifying the subject field device) as a parameter, is invoked by processing layer 220, typically when a user subscribes to status information of a specific device. Each device manager 250A-250Z requires to implement LoadDevice to build (store in internal memory 280 as well as send a copy to the processing layer 220) data corresponding to specified device along with values.

Device managers 250A-250Z may examine a device description (DD) file corresponding to a device of interest to determine the specific variable values to be retrieved and the applicable menu. As is well known in the relevant arts, a DD file is specified by a vendor for each field device type.

Thus, in operation, at the time of building the menu (with structure as well as values of the variables), if some of the variable values are required to be obtained by connecting to a field device, the device manager needs to connect to the field device using physical interface 290, and obtain values of the variables. In case of dynamic menu, the applicable menu is constructed based on the value of dynamic variable that determines the menu. The present values of the variables and the menu are stored in internal memory 280. The stored data can be used (by device manager 250B) to respond to any subsequent requests for the same data, as well as to compare with previous values.

UnloadDevice, having devicepath as parameter, is invoked by processing layer 220 typically when a specific device already loaded is not being subscribed by any of the user interfaces. Thus, processing layer 220 generally keeps track of (by storing in a RAM, not shown) the specific client systems presently subscribed to each information element. Each device manager 250A-250Z require to implement UnloadDevice procedure, to remove all the state information related to the subject field device in internal memory 280 and terminate any action being performed on to the specific device.

SubscribeParameters having device path and menu data as parameter is initiated by the processing layer 220 typically when a user subscribes to a menu of interest. Each device manager 250A-250Z implements SubscribeParameters procedure to store the specified menu data (including structure and values for the variables) in internal memory 280 and update the data according to the refresh values specified in the DD file corresponding to the device.

In addition, if the DD file indicates a menu as being dynamic, the procedure sends a request to corresponding device periodically and obtains the present value of the variables and construct present menu. The procedure further compares present data with previous data and notifies changes to processing layer 220 by using a return procedure PublishParameterValues( ) (which is implemented by processing layer 220).

UnsubscribeParameters having device path and menu data as parameter is initiated by processing layer typically when a user unsubscribes to the corresponding menu structure/variables of interest. Each device manager may implement procedure UnsubscribeParameters to delete the corresponding data from the internal memory 280. The procedure causes the (periodic) updates to also be ceased from that point of time.

Thus, to integrate the display of status information corresponding to new set of field device accessible by a new communication protocol, a designer is required to implement the set of procedures according to description provided above. As a result, implementation of the field device management system corresponding to user interface 210, processing layer 220, historical data manager 230 and portions of the device manager managing the other devices can be effectively used to provide status display of the new devices.

The description is continued with respect to configuration feature generally provided by a field device management system

6. Common Interface For Configuration of Field Devices

Configuration of field devices entails writing/storing of data onto field device. Typically, the status of the device needs to be checked to ensure that the device is in a state suitable for configuration, and configuration is performed thereafter. In an embodiment, writing operations are performed sequentially, one operation after the completion of the other.

User interface 210 sends a configuration request to processing layer 220 in response to corresponding user actions. Processing layer 220 forwards the configuration request to corresponding device manager 250A-250Z through common interface 240. Processing layer 220 receives result of the write operation through common interface 240 and sends the result to the user through user interface 210. The manner in which processing layer 220 interacts with device managers 250A-250Z (or configuration manager 270) using common interface 240 to perform configuration requests is described below.

According to an aspect of the present invention, a set of procedures are provided as common interface 240 to perform configuration of the field device connected to various control networks. In an embodiment, a procedure WriteParameter is used to configure field devices. Thus, each of the device managers 250A-250Z may be required to implement the procedure according to the description provided below.

Procedure WriteParameter is invoked by processing layer 220 upon receiving a configuration request requiring a write operation. The WriteParameter procedure accepts a device identifier, a list of parameter identifiers and corresponding values as inputs, and writes the values to the identified device. The parameter identifiers may be specified according to the corresponding device description (DD). In an embodiment, WriteParameter procedure is implemented as a blocking call, which returns a value representing the status of the write operations. Processing layer 220 may examine the returned value to determine the appropriate next action.

Each of the device managers 250A-250Z requires to implement WriteParameter procedure to generate write commands consistent with the network protocol using which the field device is accessible. Device managers 250A-250Z may examine the DD for format specific information for the write command. Data/signals consistent with the format may be sent to physical interface 290 for writing/storing desired data on the device. The implementation of the write operation depends on the specific network protocol, and will be apparent to one skilled in the relevant arts. The description is continued with respect to actions that are generally defined in the DDs for each field device, as described below in further detail.

7. Common Interface For Executing Action

Device description (DD) corresponding to each field device provides a set of routines referred to as actions that can be performed on the corresponding field devices. Each action has the effect of performing a corresponding testing/calibration of the corresponding field device. Each action is identified by the an action ID and is defined to contain several write operations to (and read operations from) the field device in a sequential manner. Each action is invoked by providing action ID. The data received from the field device while performing actions are generally forwarded to user interface 210.

User interface 210 sends a request to perform a specific action by providing action ID as reference to processing layer 220. Processing layer 220 forwards the request to the corresponding device manager using common interface 240 to invoke the action. Each device manager executes actions according to the routines provided by the DD. The manner in which processing layer 220 interacts with device manager using common interface 240 while executing an action is described below.

According to an aspect of the present invention, a set of procedures are provided as a part of common interface 240 to perform various actions according to the DD definition. In an embodiment, procedures StartAction, EndAction, and AbortAction are provided to perform various actions on the field devices. Thus, each of the device managers 250A-250Z may be required to implement the procedures according to the description provided below.

Procedure StartAction is invoked by processing layer 220 typically when user requests for an action for testing/calibrating a subject device. Hence each of the device managers 250A-250Z is required to implement StartAction to initiate an action corresponding to an actionid received as parameter. The actionid is compared with the action identifiers in the DD, and the routines (within DD) associated with the action having a matching identifier are executed. The code for the routines (e.g., in C language) is specified by the DD, and thus the code may be executed.

As noted above, data read from the field device (as a part of execution of the routines) needs to be displayed in user interface 210. Accordingly, device manager 250B displays the data using a procedure DisplayActionGetData, which can also receive additional data from a user (which is used in the execution of the action). The procedure DisplayActionGetData is thus implemented within device manager 250B. Procedure StartAction needs to abort an action-in-progress if the action response indicates a failure.

Procedure AbortAction, having device path and action ID as parameters, is initiated by the processing layer 220 typically when a user requests that a previously initiated action be aborted. AbortAction is implemented by each of the device manager 250A-250Z to abort action initiated according to the description provided in DD typically by rewriting the old value back to the device Accordingly, the prior values of variables overwritten, need to be kept track during execution of the actions.

EndAction, having device path and action ID, is invoked by processing layer 220 to request an end to a presently executed action. The endAction procedure differs from AbortAction procedure in that the old value is not written back to the device.

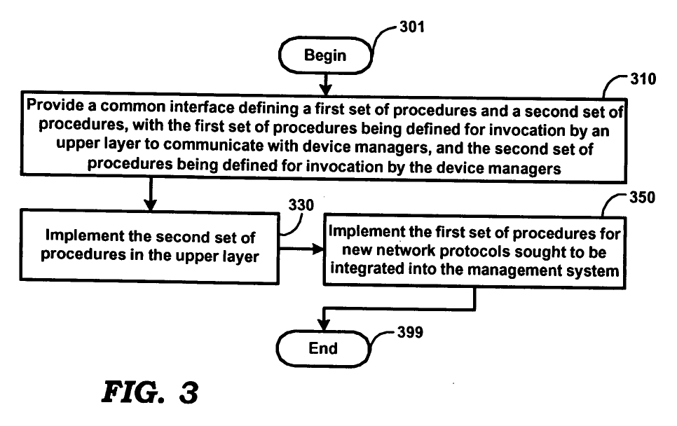

It should be understood that only example management actions are described above for illustration. However, alternative embodiments can contain fewer or more management actions without departing from the scope and spirit of several aspects of the present invention. However, the common interface described above simplifies integration of management of field device accessible by new protocols, as described below in further detail with respect to FIG. 3.

8. Integrating New Network Protocols

FIG. 3 is a flowchart illustrating the manner in which management of field devices accessible by new protocols can be integrated into a management station according to an aspect of the present invention. The flowchart is described with reference to FIGS. 1 and 2 above merely for illustration. However, the approaches can be implemented in other environments as well. The flowchart begins in step 301, in which control passes to step 310.

In step 310, central server 150 is implemented to provide a common interface defining a first set of procedures and a second set of procedures, with the first set of procedures being defined for invocation by an upper layer (processing layer 220 in the above description) to communicate with device managers, and the second set of procedures being defined for invocation by the device managers.

In step 330, the second set of procedures are implemented in the upper layer (within central server 150). As may be appreciated from the above description, the second set of procedures are protocol independent, and are tied to the specific management actions sought to be implemented. A designer may choose any set of management actions, as suited for the specific environment, and the corresponding procedures are implemented as the second set of procedures.

In step 350, the first set of procedures are implemented within the device manager corresponding to the new network protocols sought to be integrated into central server 150. Due to such an approach, the integration task may substantially entail implementation of the first set of procedures in central server 150. Other tasks such as configuration of the upper layer, would also need to be performed, as will be apparent to one skilled in the relevant arts. The flowchart ends in step 399.

It should be further appreciated that the features described above can be implemented in various embodiments. The description is continued with respect to an embodiment in which various features are operative when software instructions are executed.

9. Digital Processing System

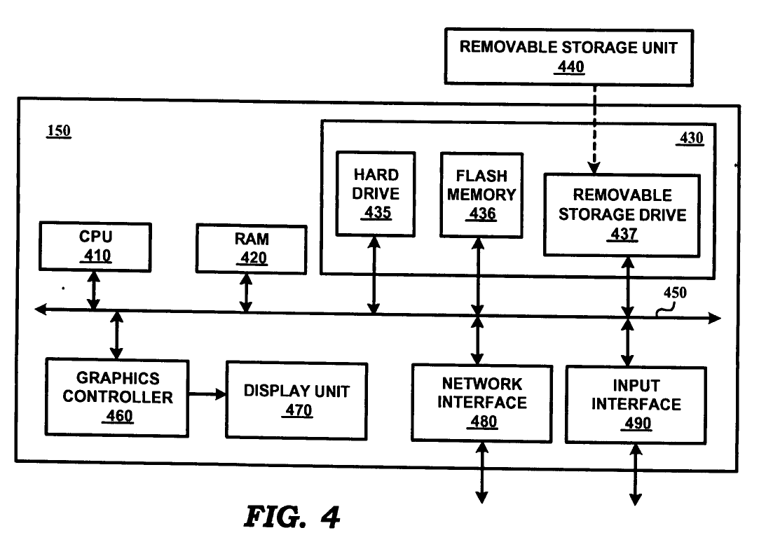

FIG. 4 is a block diagram illustrating the details of central server 150 in which various aspects of the present invention are operative by execution of appropriate software instructions. Central server 150 may contain one or more processors such as central processing unit (CPU) 410, random access memory (RAM) 420, secondary memory 430, graphics controller 460, display unit 470, network interface 480, and input interface 490. All the components except display unit 470 may communicate with each other over communication path 450, which may contain several buses as is well known in the relevant arts. The components of FIG. 4 are described below in further detail.

CPU 410 may execute instructions stored in RAM 420 to provide several features of the present invention. CPU 410 may contain multiple processing units, with each processing unit potentially being designed for a specific task. Alternatively, CPU 410 may contain only a single general purpose processing unit. RAM 420 may receive instructions from secondary memory 430 using communication path 450.

Graphics controller 460 generates display signals (e.g., in RGB format) to display unit 470 based on data/instructions received from CPU 410. Display unit 470 contains a display screen to display the images defined by the display signals. Input interface 490 may correspond to a key-board and/or mouse. Network interface 480 contains multiple physical interfaces, which provide connectivity to various control networks as well as client systems providing user interface 210.

Secondary memory 430 may contain hard drive 435, flash memory 436 and removable storage drive 437. Secondary memory 430 may store the data and software instructions (e.g., methods instantiated by each of client system), which enable central server 150 to provide several features in accordance with the present invention. Some or all of the data and instructions may be provided on removable storage unit 440, and the data and instructions may be read and provided by removable storage drive 437 to CPU 410. Floppy drive, magnetic tape drive, CD-ROM drive, DVD Drive, Flash memory, removable memory chip (PCMCIA Card, EPROM) are examples of such removable storage drive 437.

Removable storage unit 440 may be implemented using medium and storage format

compatible with removable storage drive 437 such that removable storage drive 437 can read

the data and instructions. Thus, removable storage unit 440 includes a computer readable storage medium having stored therein computer software and/or data.

In this document, the term “computer program product” is used to generally refer to removable storage unit 440 or hard disk installed in hard drive 435. These computer program products are means for providing software to central server 150. CPU 410 may retrieve the software instructions, and execute the instructions to provide various features of the present invention described above.

10. Conclusion

While various embodiments of the present invention have been described above, it should be understood that they have been presented by way of example only, and not limitation. Thus, the breadth and scope of the present invention should not be limited by any of the above described exemplary embodiments, but should be defined only in accordance with the following claims and their equivalents.

What is claimed is:

1. A method of facilitating integration of management of a plurality of field devices into a field device management system, wherein said plurality of field devices are accessible by a new network protocol, said plurality of field devices being comprised in a process control plant, said method comprising:
providing a common interface containing a first plurality of procedures and a second plurality of procedures, wherein said first plurality of procedures are invoked by an upper layer to initiate a plurality of management actions on a device of interest independent of a protocol by which said device is accessible, wherein each of said second plurality of procedures is implemented by said upper layer,
wherein integration of management of said plurality of field devices can be attained by adding a device manager which implements said first plurality of procedures according to said new network protocol, and communicates with said upper layer using said second plurality of procedures,
whereby said integration is simplified due to said common interface.

2. The method of claim 1, wherein said plurality of management actions comprise generating a network map of said plurality of field devices, wherein said first plurality of procedures comprises a first procedure having a network identifier as a parameter, wherein said first procedure determines said network map by interfacing with said plurality of field devices and invokes a second procedure to return data representing said network map, said second procedure being contained in said second plurality of procedures.

3. The method of claim 1, wherein said plurality of management actions comprise displaying status information of a first field device comprised in said plurality of field devices, said first plurality of procedures comprising a third procedure specifying an identifier of said first field device, wherein said third procedure retrieves said status information from said first field device and stores the information in a memory.

4. The method of claim 3, wherein said first plurality of procedures comprises a fourth procedure which subscribes to a portion of said status information, wherein a fifth procedure contained in said second plurality of procedures publishes changes in said portion to said upper layer.

5. The method of claim 4, further comprises a sixth procedure contained in said first plurality of procedures which unsubscribes to said portion, wherein said device manager stops updating said portion in response to said sixth procedure being invoked by said upper layer.

6. The method of claim 1, wherein said plurality of management actions comprise configuring said plurality of field devices, said first plurality of procedures containing a seventh procedure which receives a device identifier and a set of parameters indicating a list of variables and corresponding values, wherein said seventh procedure performs a writing operation to cause said list of variables to be set to corresponding values in a field device identified by said identifier.

7. The method of claim 1, wherein said plurality of management actions comprise executing a plurality of routines specified by a device description corresponding to a first field device contained in said plurality of field devices, said first plurality of procedures containing a eighth procedure having a device identifier and a action identifier as parameters, wherein said eighth procedure identifies said plurality of routines associated with said action identifier and executes said plurality of routines.

8. The method of claim 7, wherein said second plurality of procedures containing a ninth procedure sending to said upper layer a data representing a display, wherein said ninth procedure enables said device manager to receive user inputs while providing said display.

9. The method of claim 8, wherein said first plurality of procedures contain a tenth procedure which requests termination of execution of said plurality of routines.

10. A computer readable medium carrying one or more sequences of instructions facilitating integration of management of a plurality of field devices into a field device management system, wherein said plurality of field devices are accessible by a new network protocol, said plurality of field devices being comprised in a process control plant, wherein execution of said one or more sequences of instructions by one or more processors contained in said field device management station causes said one or more processors to perform the actions of:
providing a common interface containing a first plurality of procedures and a second plurality of procedures, wherein said first plurality of procedures are invoked by an upper layer to initiate a plurality of management actions on a device of interest independent of a protocol by which said device is accessible, wherein each of said second plurality of procedures is implemented by said upper layer,
wherein integration of management of said plurality of field devices can be attained by adding a device manager which implements said first plurality of procedures according to said new network protocol, and communicates with said upper layer using said second plurality of procedures,
whereby said integration is simplified due to said common interface.

11. The computer readable medium of claim 10, wherein said plurality of management actions comprise generating a network map of said plurality of field devices, wherein said first plurality of procedures comprises a first procedure having a network identifier as a parameter, wherein said first procedure determines said network map by interfacing with said plurality of field devices and invokes a second procedure to return data representing said network map, said second procedure being contained in said second plurality of procedures.

12. The computer readable medium of claim 10, wherein said plurality of management actions comprise displaying status information of a first field device comprised in said plurality of field devices, said first plurality of procedures comprising a third procedure specifying an identifier of said first field device, wherein said third procedure retrieves said status information from said first field device and stores the information in a memory.

13. The computer-readable medium of claim 12, wherein said first plurality of procedures comprises a fourth procedure which subscribes to a portion of said status information, wherein a fifth procedure contained in said second plurality of procedures publishes changes in said portion to said upper layer.

14. The computer readable medium of claim 13, further comprises a sixth procedure contained in said first plurality of procedures which unsubscribes to said portion, wherein said device manager stops updating said portion in response to said sixth procedure being invoked by said upper layer.

15. The computer readable medium of claim 10, wherein said plurality of management actions comprise configuring said plurality of field devices, said first plurality of procedures containing a seventh procedure which receives a device identifier and a set of parameters indicating a list of variables and corresponding values, wherein said seventh procedure performs a writing operation to cause said list of variables to be set to corresponding values in a field device identified by said identifier.

16. The computer readable medium of claim 10, wherein said plurality of management actions comprise executing a plurality of routines specified by a device description corresponding to a first field device contained in said plurality of field devices, said first plurality of procedures containing a eighth procedure having a device identifier and a action identifier as parameters, wherein said eighth procedure identifies said plurality of routines associated with said action identifier and executes said plurality of routines.

17. The computer readable medium of claim 16, wherein said second plurality of procedures containing a ninth procedure sending to said upper layer a data representing a display, wherein said ninth procedure enables said device manager to receive user inputs while providing said display.

18. The computer readable medium of claim 17, wherein said first plurality of procedures contain a tenth procedure which requests termination of execution of said plurality of routines.

19. An apparatus facilitating integration of management of a plurality of field devices into a field device management system, wherein said plurality of field devices are accessible by a new network protocol, said plurality of field devices being comprised in a process control plant, said apparatus comprising:
means for providing a common interface containing a first plurality of procedures and a second plurality of procedures, wherein said first plurality of procedures are invoked by an upper layer to initiate a plurality of management actions on a device of interest independent of a protocol by which said device is accessible, wherein each of said second plurality of procedures is implemented by said upper layer,
wherein integration of management of said plurality of field devices can be attained by adding a device manager which implements said first plurality of procedures according to said new network protocol, and communicates with said upper layer using said second plurality of procedures,
whereby said integration is simplified due to said common interface.
